(19) United States
(12) Patent Application Publication
(10) Pub. No.: US 2019/0095868 A1
(43) Pub. Date: Mar. 28, 2019

(54) METHODS AND SYSTEMS FOR CONVERTING UNSTRUCTURED TEXT INTO STRUCTURED JOB POSTINGS

(71) Applicant: Facebook, Inc., Menlo Park, CA (US)

(72) Inventors: Ying Zhang, Palo Alto, CA (US); Wenzhe Jiang, Seattle, WA (US); Lei Sun, Fremont, CA (US); Zain Rehmani, Fremont, CA (US); Cheng Yang, Foster City, CA (US); Gaurav Dosi, Emryville, CA (US)

(21) Appl. No.: 15/718,601

(22) Filed: Sep. 28, 2017

(51) Int. Cl. G06Q 10/10; G06F 17/30; G06Q 50/00

(52) U.S. Cl. CPC G06Q 10/1053; G06N 99/005; G06Q 50/01; G06F 17/30477

(57) ABSTRACT

Exemplary embodiments relate to techniques for identifying job listing posts in a platform, such as a social networking or messaging service. Job listing posts can be identified as they are created, causing the user to enter a job posting interface for entering structured data. The structured data may be searchable on the platform. Job posts can also be identified post hoc, and subsequently converted to structured job listing posts. Structured information may be drawn from the freeform text, and the system may normalize the job description (e.g., using third-party information, such as standard job descriptors). Identifying a job listing post/intent may be done using a model trained using various parameters, such as: user feedback/administrator actions; corrections; content of the post; existing posts of page owner; the time of year; whether other employers in similar fields are post job openings; and whether this owner prefers to write structured or unstructured posts.

### BACKGROUND

As social networking and messaging platforms have increased in popularity, users have begun relying on these platforms for activities that extend beyond typical social interactions. In many cases, such platforms are becoming nexuses for job hunting. For instance, employers may post employment opportunities on social networking services, job seekers may search for such postings, and job seekers and employers may communicate with one another and/or other contacts about their search.

Currently, these activities are carried out on the platform in an ad hoc manner. For instance, employers may create a post using unstructured, freeform text describing the job posting. This may make it difficult for job seekers to find the job posting and/or identify characteristics of the job (e.g., field of work, location, educational and experience requirements, etc.).

On the other hand, job seekers may interact with the platform in a manner that telegraphs their intent to search for a job (e.g., clicking on job posts, sending a message indicating their desire to find a new job, etc.). Currently, social networking and messaging platforms do not leverage these interactions to assist job seekers.

### BRIEF DESCRIPTION OF THE DRAWINGS

FIG. 1A depicts an exemplary interface displaying an in-progress posting created by a job poster.

FIG. 1B depicts an exemplary interface querying the job poster as to whether they would like to create a structured job post.

FIG. 1C depicts an exemplary interface displaying a structured job post

FIG. 1D depicts an exemplary interface displaying a user post evidencing that the user is a job seeker.

FIG. 1E depicts an exemplary interface presenting employment opportunities to a user in an interactable list.

FIG. 2 depicts an exemplary job listing and job seeker analysis system.

FIG. 3A is a flowchart descri may bing exemplary logic for analyzing an in-progress post to determine whether the post includes a job listing.

FIG. 3B is a flowchart describing exemplary logic for analyzing a previously constructed post to determine whether the post includes a job listing.

FIG. 4 is a flowchart describing exemplary logic for determining whether a user is a job seeker and for surfacing job opportunities to the user.

FIG. 5A is a block diagram providing an overview of a system including an exemplary centralized messaging service;

FIG. 5B is a block diagram providing an overview of a system including an exemplary distributed messaging service;

FIG. 5C depicts the social networking graph of FIGS. 5A-5B in more detail;

FIG. 6 is a block diagram depicting an example of a system for a messaging service;

FIG. 7 is a block diagram illustrating an exemplary computing device suitable for use with exemplary embodiments;

FIG. 8 depicts an exemplary communication architecture; and

FIG. 9 is a block diagram depicting an exemplary multicarrier communications device.

### DETAILED DESCRIPTION

Exemplary embodiments relate to techniques for identifying job listing posts and job seekers on a platform, such as a social networking service or a messaging service.

Job listing posts may be identified as they are created, causing the user to enter a job posting interface for entering structured data. Job posts may also be identified post hoc, and subsequently converted to structured job listing posts.

In either event, the job post may be identified by reviewing unstructured data, such as freeform text present in a social networking post or a message of a messaging service. Structured information pertaining to an employment opportunity may be drawn from the freeform text. The structured data may be searchable through the platform.

Identifying a job listing post may be accomplished via a model trained using various features. The features may include, for example, corrections, user feedback or administrator actions pertaining to job posts and/or the conversion process. For instance, if the system identifies a particular post as a job listing, but a user or administrator manually flags the post as not corresponding to a job listing (or vice versa), the model may adjust one or more parameters of the model to make it less (or more) likely that similar postings will be identified as job listings in the future. Similarly, the model may rely on the content of the post (e.g., whether the post includes content items generally associated with job listings, such as educational or experience requirements, title information, salary information, hours, etc.). When considering whether to convert a preexisting unstructured post into a structured job listing, the system may also consider any comments made on the post.

When considering whether one of the posts of a given user is a job listing, the system may consider other posts of the user. For example, if the user has recently posted several job listings, it may be more likely that the current post is a job listing. In another example, if the user has recently posted that they will be hiring soon or provides other cues indicating the possibility of a future job posting, the probably that a given post is a job posting may be elevated (or vice versa, if the user indicates that they are no longer searching for candidates). In another example, the model may consider posts of other users in the same field as the current user. For instance, if other users in the same field indicate that they are seeking job candidates, the system may infer that the current user is more likely to also be seeking candidates.

The model may also incorporate temporal information. For example, if a user is associated with a given field that tends to hire workers at a certain time of year (e.g., package delivery and warehouse workers in the holiday season, lifeguards and landscapers in the summer, etc.), the system may consider whether the user's field is currently in a hiring season (or, alternatively, if the user's field is currently downsizing).

Still further, the model may consider whether the user prefers to create structured or unstructured posts. If the user prefers to create structured posts, the system may more readily offer an opportunity to convert something that looks like a job posting into structured data. On the other hand, if the user only rarely creates structured posts, the system may refrain from offering the opportunity to present the job posting in a structured manner.

In exemplary embodiments, elements of the job description may be normalized. For example, certain terms may be replaced with industry-standard job descriptors, potentially drawn from third-party sources.

Further embodiments, which may be used separately or in conjunction with the embodiments described above, relate to techniques for identifying job seekers on the platform and presenting them with the job postings that they are most likely to be interested in.

The system may determine the job seeker's intent based, for example, on whether the user has clicked into a job posting in a certain time period, based on the contents of their posts and messages (e.g., a message stating “anybody looking for help? I'm job hunting”), based on whether the user has recently uploaded a resume to the platform, etc. The system may rank job postings by the probability that a user will be interested in a particular job (e.g., based on the user's profile information available through the platform). For example, the system may consider the user's educational background, location, employment experience, interests, connections, skills, etc. in determining which jobs may be a suitable fit for the user.

The system may surface employment opportunities to the user in a number of ways (e.g., in a promoted post, an ad, a dedicated searchable job browser, or the user's news feed).

In some embodiments, the system may determine whether a user is actively seeking a new job, or whether the user's interest is more passive. For example, if the user currently has a job, but could be convinced to take a new job if the correct opportunity arose, the system may classify the user as a passive job seeker. On the other hand, if the user is actively seeking a new job, engaging in interviews, etc., the user may be classified as an active job seeker. The system may treat active job seekers differently than passive job seekers. Active job seekers may be presented with more job listings, potentially including job listings that may be of more marginal interest to the user (e.g., in a field tangential to the user's interests). On the other hand, passive job seekers may be presented with job opportunities more rarely (in order to avoid spamming the user) and/or may only be presented with opportunities that the system determines with high probability will be of interest to the user.

In one embodiment, applicable jobs may be surfaced in an interactable (e.g., scrollable) list. If the user interacts with the list, then the system may determine that the user is a job seeker and that the posted jobs are in their field of interest. If the user does not interact with the list, then one of those elements is considered to be missing. In this circumstance, the system may adjust the offered jobs if it is determined to be likely that the user is looking for a job but not interested in the specific jobs in the post.

This brief summary is intended to serve as a non-limiting introduction to the concepts discussed in more detail below. However, before discussing further exemplary embodiments, a brief note on data privacy is first provided. A more detailed description of privacy settings and authentication will be addressed in connection with the following Figures.

A Note on Data Privacy

Some embodiments described herein make use of training data or metrics that may include information voluntarily provided by one or more users. In such embodiments, data privacy may be protected in a number of ways.

For example, the user may be required to opt in to any data collection before user data is collected or used. The user may also be provided with the opportunity to opt out of any data collection. Before opting in to data collection, the user may be provided with a description of the ways in which the data will be used, how long the data will be retained, and the safeguards that are in place to protect the data from disclosure.

Any information identifying the user from which the data was collected may be purged or disassociated from the data. In the event that any identifying information needs to be retained (e.g., to meet regulatory requirements), the user may be informed of the collection of the identifying information, the uses that will be made of the identifying information, and the amount of time that the identifying information will be retained. Information specifically identifying the user may be removed and may be replaced with, for example, a generic identification number or other non-specific form of identification.

Once collected, the data may be stored in a secure data storage location that includes safeguards to prevent unauthorized access to the data. The data may be stored in an encrypted format. Identifying information and/or non-identifying information may be purged from the data storage after a predetermined period of time.

Although particular privacy protection techniques are described herein for purposes of illustration, one of ordinary skill in the art will recognize that privacy protected in other manners as well. Further details regarding data privacy are discussed below in the section describing network embodiments.

Assuming a user's privacy conditions are met, exemplary embodiments may be deployed in a wide variety of messaging systems, including messaging in a social network or on a mobile device (e.g., through a messaging client application or via short message service), among other possibilities. An overview of exemplary logic and processes for engaging in synchronous video conversation in a messaging system is next provided

As an aid to understanding, a series of examples and background information will first be presented before detailed descriptions of the underlying implementations are described. It is noted that these examples are intended to be illustrative only and that the present invention is not limited to the embodiments shown.

### Exemplary Interfaces

Reference is now made to the drawings, wherein like reference numerals are used to refer to like elements throughout. In the following description, for purposes of explanation, numerous specific details are set forth in order to provide a thorough understanding thereof. However, the novel embodiments can be practiced without these specific details. In other instances, well known structures and devices are shown in block diagram form in order to facilitate a description thereof. The intention is to cover all modifications, equivalents, and alternatives consistent with the claimed subject matter.

In the Figures and the accompanying description, the designations “a” and “b” and “c” (and similar designators) are intended to be variables representing any positive integer. Thus, for example, if an implementation sets a value for a=5, then a complete set of components 122 illustrated as components 122-1 through 122-a may include components 122-1, 122-2, 122-3, 122-4, and 122-5. The embodiments are not limited in this context.

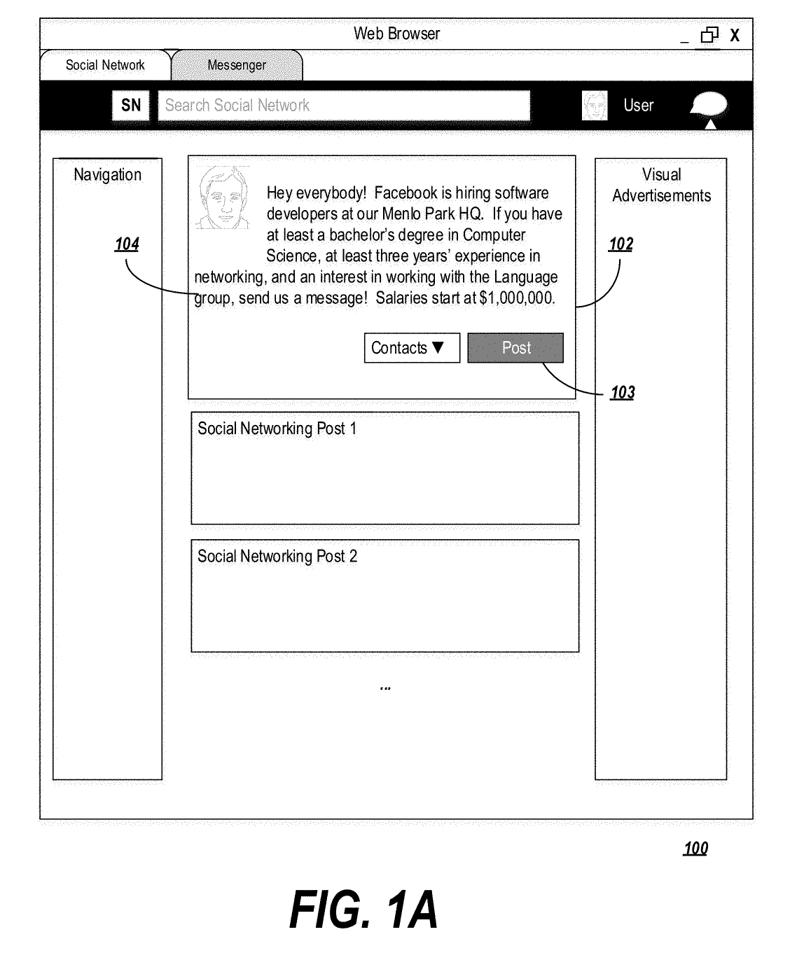

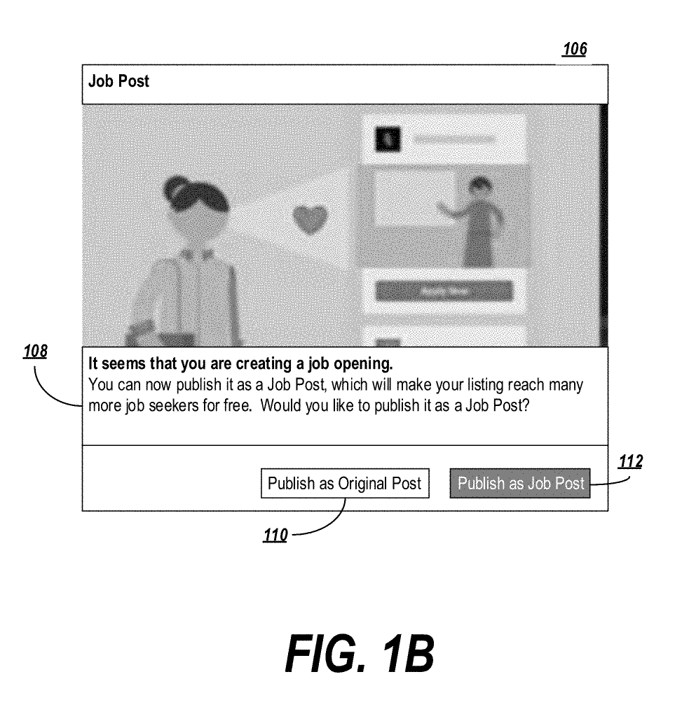

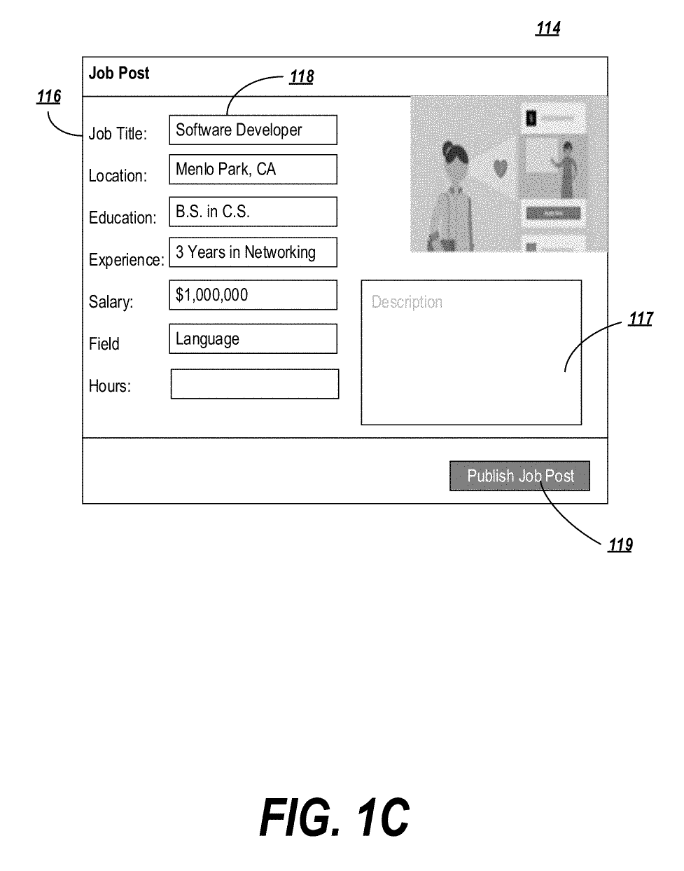

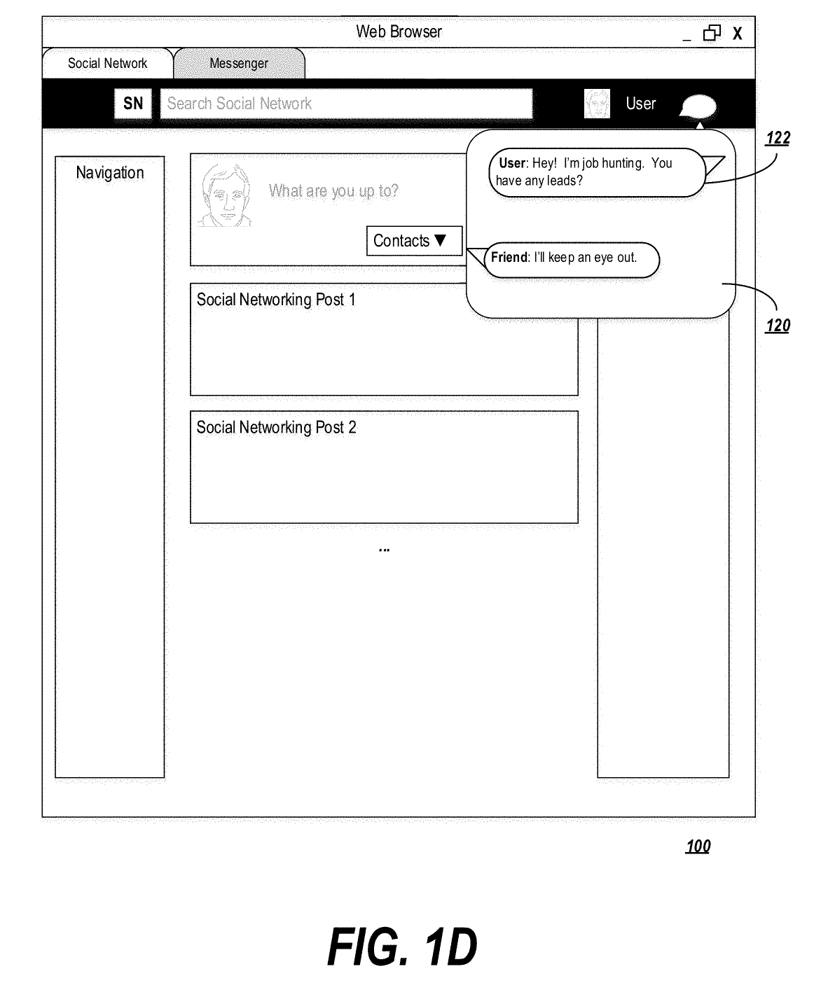

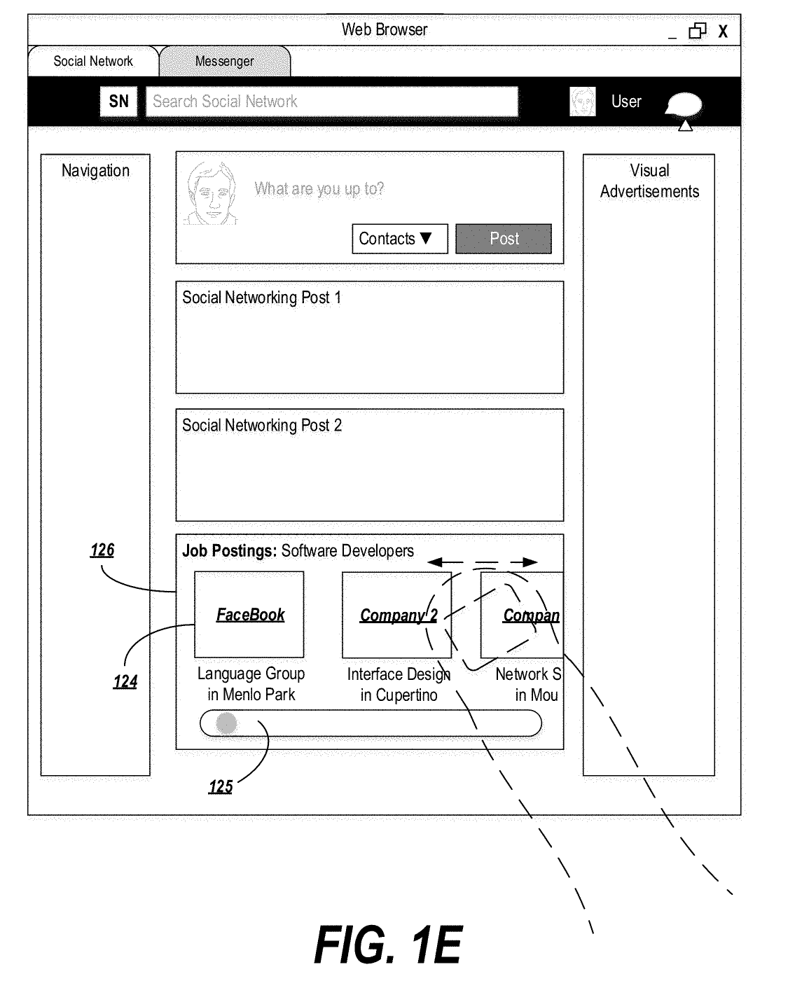

FIG. 1A depicts an exemplary interface 100 displaying an in-progress posting 102 being created by a user. Interface 100 may be, for example a social networking interface generated by a social networking service, and may be accessible via a web browser or via a dedicated app on a user device. Interface 100 may also be for any other type of service, for example, a generic messaging service, such as an email service or short messaging service (SMS). Interface 100 may be generated by a service specifically for the posting and reviewing of job openings. A description of the invention is made in the context of postings made by users on a social networking service, however, the invention is not meant to be limited thereby.

Users may post messages using the interface 100, the messages containing information of any subject of interest to the user, or which the user thinks may be of interest to other users in the social network. User posts typically comprise unstructured free-form text 104, but may include other items, for example, media attachments, including pictures, videos, sound clips, etc. The user may complete the post by clicking on the “Post” button 103, which may make the post accessible to other users of the social networking service.

FIG. 1A shows a user composing a post 102 comprising unstructured free-form text 104. In this case, the unstructured free-form text 104 describes a job opening, containing job listing information. The unstructured free-form text 104 may be identified as a job posting by the social networking service. The description of the job opening shown in FIG. 1A may be identified by the social networking service as a job description using a machine learning model which has been trained using various features or via a keyword search.

FIG. 1B depicts an exemplary interface querying the job poster as to whether they would like to create a structured job post based on their unstructured free-form text 104. Once the machine learning model has identified the unstructured free-form text 104 entered by the user in post 102 as a description of a job opening, the social networking service may display query interface 106 which queries the user as to whether they would prefer to publish the posting as a structured job post, or leave the unstructured free-form text 104 as originally entered by the user. User prompt 108 informs the user that the unstructured free-form text 104 has been recognized as a potential job opening and explains to the user that the job opening may be published as a structured job post.

Query interface 106 may contain buttons which user may click in response to the query. As shown in FIG. 1B, the user has the option of publishing the unstructured free-form text 104 as it was originally entered by the user by clicking on button 110. Alternatively, the user has the option of publishing the unstructured free-form text 104 as a structured job post by clicking button 112. Should the user choose to publish the unstructured free-form text 104 as a structured job post, the service will extract as much information from the unstructured free-form text 104 and make a best effort to fit that information into the structured form of the job posting. The structured job post may be stored in a searchable database and/or posted in a job listing service provided by the social networking service, or in a job listing service external to the social networking service.

FIG. 1C depicts an exemplary interface displaying a structured job post. In the event that the user clicks button 112 shown in FIG. 1B, indicating that he wishes for a structured job posting to be created based upon the entered unstructured free-form text 104, structured job posting interface 114 is presented to the user. The structured job posting may contain a plurality of specific job-related parameters 116, including for example, the title of the job, the location of the job, the education required for the job, the experience required for the job, the salary paid by the job, the field in which a job is located, and the hours of the job. This list of parameters is an exemplary list, and the invention is not meant to be limited thereby. It would be realized by one of skill in the art that many other parameters associated with a job opening may be listed.

FIG. 1C also shows values 118 for structured parameters 116. The values initially presented to the user may be extracted directly from unstructured free-form text 104 entered in the user's original posting 102. The social networking service may utilize a keyword search or a trained machine learning model to extract values 118 and recognize them as being associated with various parameters 116. Note that not all of the structured parameters 116 may contain values 118. The service, when parsing the unstructured free-form text 104 in the user's posting may not have been able to identify a value 118 for each of parameters 116. In addition, some values 118 may have been misidentified as pertaining to a particular parameter 116. As such, the user, using structured job listing interface 114, has an opportunity to edit the value 118 for each parameter 116, and to fill in values 118 for parameters 116 for which values 118 were not able to be identified from the unstructured free-form text 104 appearing in the user's posting. Structured job posting interface 114 may also include a description box 117 in which the user may enter free-form text describing particulars of the job opening not adequately described by the values 118 associated with structured parameters 116. In some embodiments, the values 118 associated with certain parameters 116 may be normalized to contain industry-standard job descriptors, potentially drawn from third-party sources.

FIG. 1C may also present a user with a button 119 which the user may click to publish the job posting once the user has completed the editing of values 118 associated with parameters 116. Once the user clicks on the button to publish the structured job posting, the structured job posting will be listed on a job listing service of the social networking service, or with other online services. For example, the structured job listing may be posted on a networking service specific to the listing of job openings and the matching of potential employees to job openings, which may or may not be affiliated with the social networking service. In addition, the structured job listing maybe stored in a searchable database.

FIG. 1D depicts an exemplary interface 100 displaying a user post containing text from which it may be deduced that the user is a job seeker. Exemplary interface 100 may be the same interface used by a job poster as illustrated in FIG. 1A, and may be, for example a social networking interface generated by a social networking service, which may be accessible via a web browser or dedicated app on a user device.

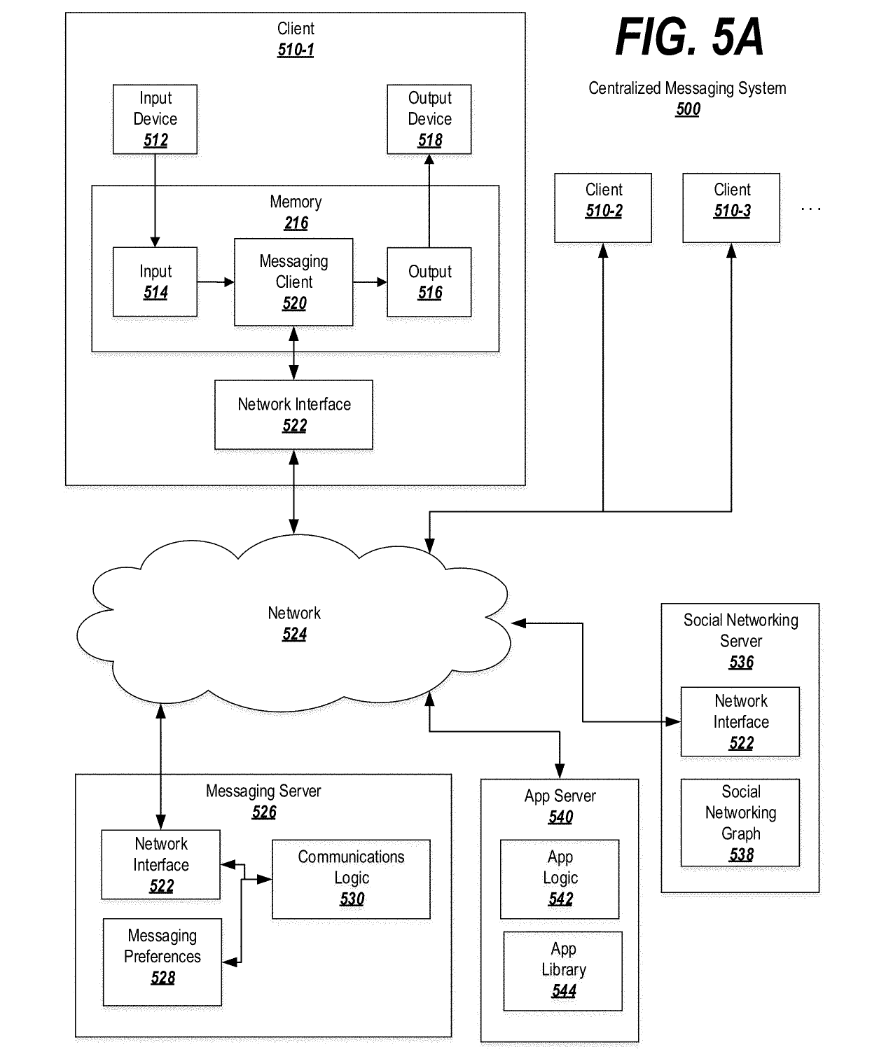

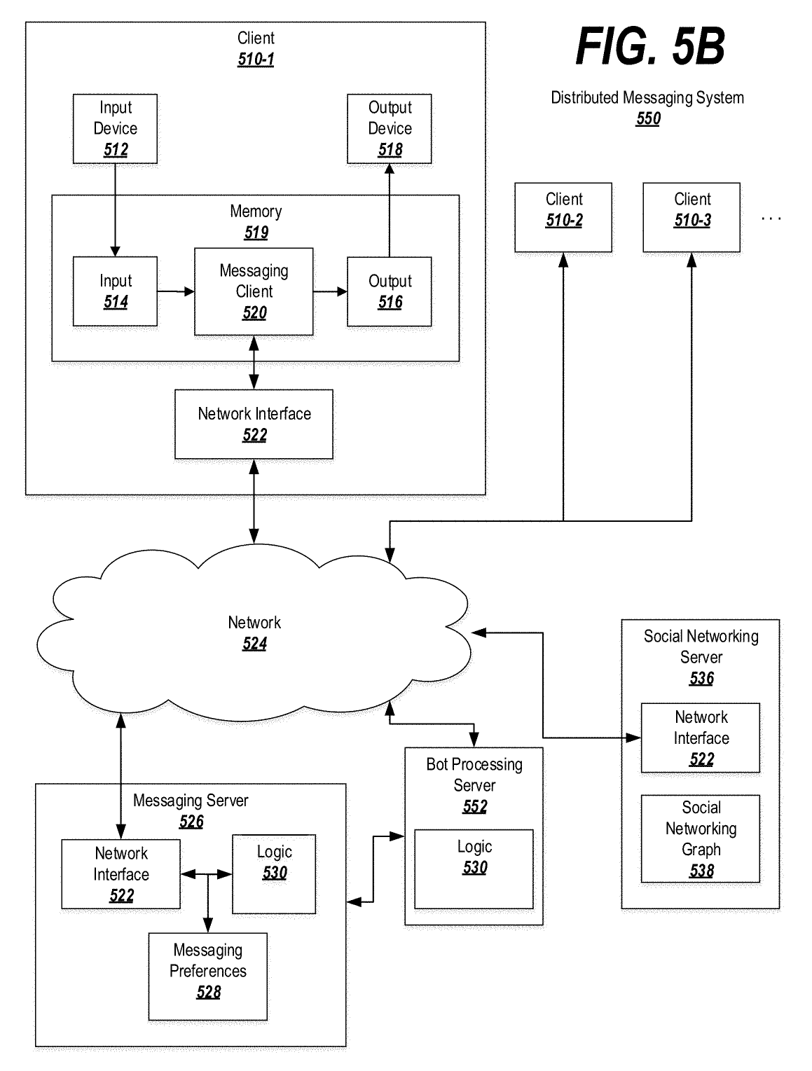

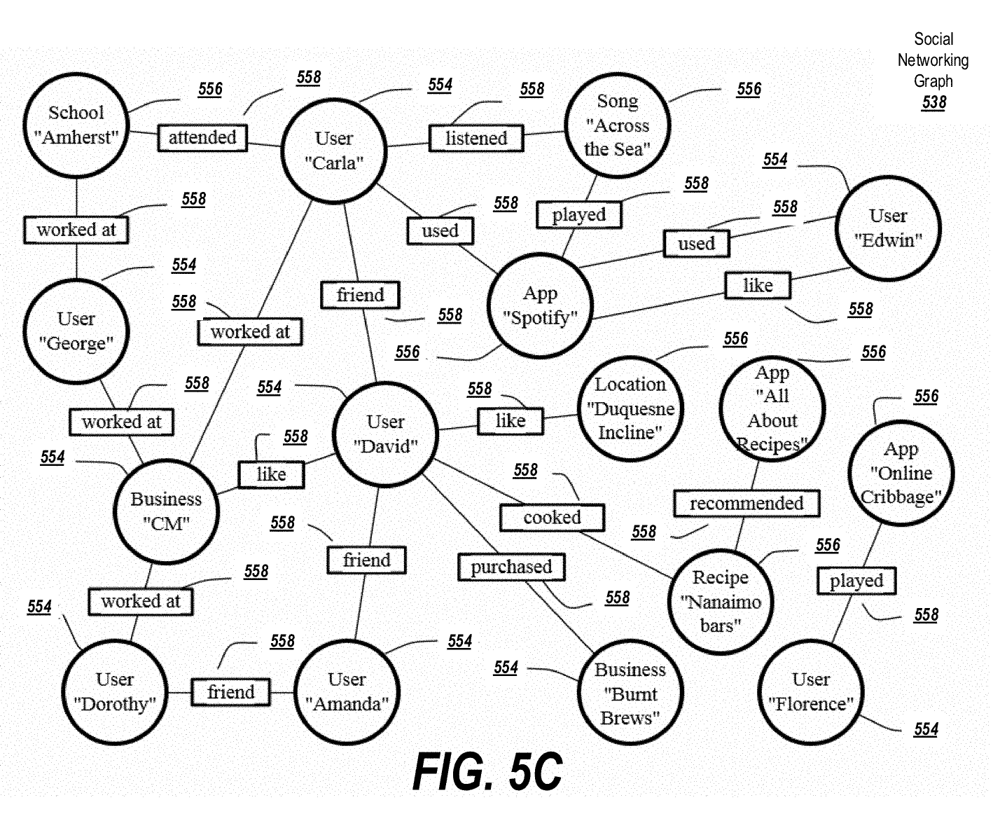

FIG. 1D shows a job-seeking user using the messaging service 120 of a social networking service to send a message to another user of the social networking service indicating that the job-seeking user is looking for a job, at 122. The other user may have a connection with the job-seeking user as indicated by an edge in a social graph between the other user and the job-seeking user, examples of which are shown in FIG. 5C. The connection may be for example a “friend” connection, another type of connection, or in some cases the other user may have no connection with the job-seeking user. The user to which the messages sent may optionally send a response to the job-seeking user.

Messages 122 sent using messaging service 120 may be monitored by the social networking service to detect potential job seekers, subject to the privacy settings of the users. Job seekers may be identified by the social networking service using a machine learning model which has been trained using various features. Alternatively, a job-seeking user may make a general post in a manner similar to the post made by the job-posting user shown in FIG. 1A, indicating that the job-seeking user is considering a new position. As with the messaging service 120, potential job-seeking users may be identified using the machine learning model.

FIG. 1E depicts an exemplary interface presenting employment opportunities to a user in an interactable list. Applicable jobs may be presented to the user in an interactable list 126, containing individual job listings 124 which user may scroll through utilizing a finger movement as indicated in FIG. 1E, or utilizing scrollbar 125. In one embodiment, the applicable jobs may be presented to the user without the user being identified as a job-seeking user, but for the purpose of determining that the user is a job seeker. If the user interacts with the list, that may indicate that the user may be an active or passive job seeker. If the user does not interact with the list, the system may adjust the job offers if it is determined to be likely that the user is looking for a job based on other factors, but not interested in the specific jobs listed.

In other embodiments, the applicable jobs 124 may be presented to the user in the interactable list 126 after the user has been identified as a job-seeking user, based either on an analysis of a private message sent directly to another user on the social networking service, or based on an analysis of a general posting made by the job-seeking user on the social networking service, or based on other factors utilized by the machine learning model. In other embodiments, the social networking system may present employment opportunities to the user in a number of alternative ways, including, for example, in a promoted post, in an ad, in a dedicated searchable job browser, or in the user's newsfeed. It would be realized by one of skill in the art that this list is exemplary in nature and that other means of presenting job offers to job-seeking users are within the scope of the invention.

### Exemplary Job Listings/Seekers Analysis System

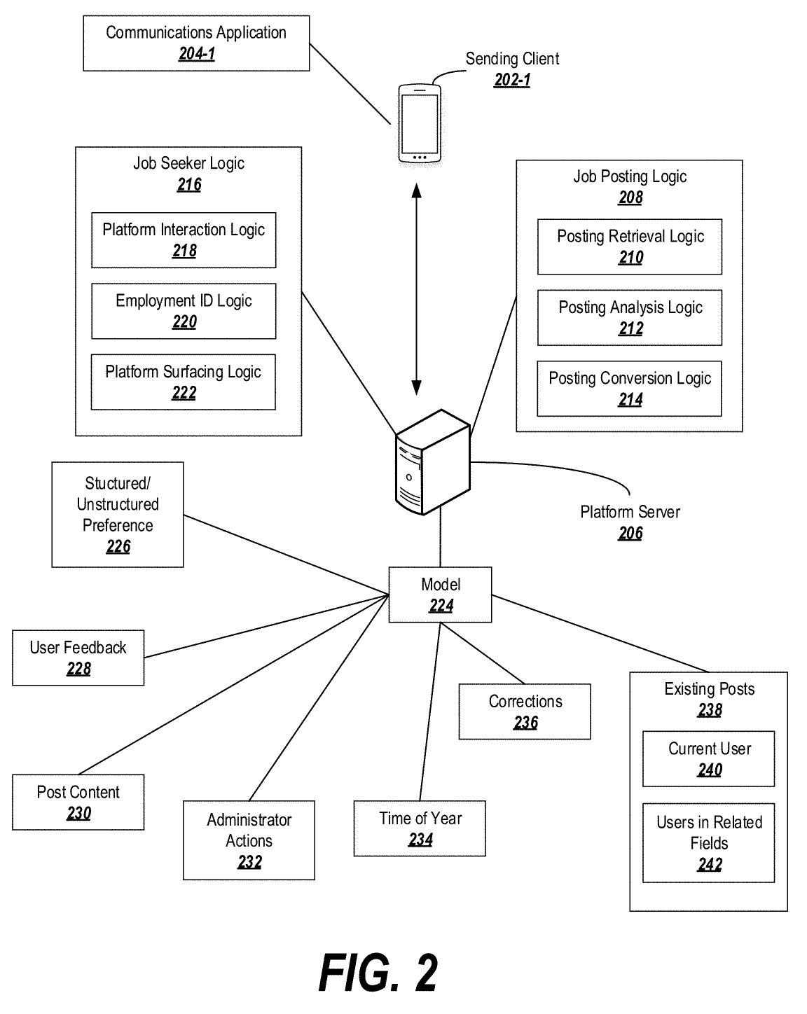

FIG. 2 depicts an exemplary job listing and job seeker analysis system. Platform server 206 is a server accessible over the Internet which may provide a service with which users may interact to create job listings and/or to seek job listings. In an exemplary embodiment, platform server 206 is a social networking service server, however it will be realized by one of skill in the art that any type of service may be served by platform server 206. For purposes herein, the invention will be explained in the context of a social networking service, however, the invention is not meant to be limited thereby. Further, it should be realized that platform server may not be a single server, but may be represented by a server farm containing many servers serving many users simultaneously.

Users may interact with the service served by platform server 206 utilizing sending client device 202-1. Sending client device 202-1 may be any type of computing device capable of interacting with platform server 206 over the Internet, including, for example, smartphones, tablets, laptops, desktops or any other type of computing device now known or later developed. Sending client 202-1 may run a communications application 204-1, which may be, for example, a web browser capable of displaying a webpage served by platform server 206, or a dedicated application capable of interacting with a social networking service served by platform server 206. Many sending client devices 202-1 . . . 202-N may be accessing the service served by platform server 206 simultaneously.

Platform server 206 may comprise job posting logic 208. Job posting logic 208 handles the identification of potential job postings identified in user interactions with the service including, for example, general posts and private messages, and the conversion of those postings to standardize job postings. Job posting logic 208 may comprise posting retrieval logic 210, posting analysis logic 212 and posting conversion logic 214.

Posting retrieval logic 210 may be configured to detect unstructured free-form text 104 on the social networking service. The unstructured free-form text 104 may be in the form of postings made by job-posting users, messages sent by job-posting users or any other form of unstructured free-form text permitted by the service. The posting retrieval logic 210 may retrieve posts and messages in an ad hoc manner, that is, as they are being composed, or in a post hoc manner, that is, after they have been composed. The posting retrieval logic 210 may retrieve all posts and messages, or may identify a subset of posting messages for retrieval and analysis.

Posting analysis logic 212 may be configured to identify, from the unstructured free-form text 104 detected and retrieved by posting retrieval logic 210, that the unstructured text corresponds to an employment opportunity or job listing. Posting analysis logic 212 may utilize machine learning model 224, trained on a variety of features, to perform the analysis.

Model 224 may be a machine learning model trained using various features to identify postings which may comprise job listings. The features may include, for example, corrections made by users 236, user feedback 228, administrator actions pertaining to job posts 232, post content 230 and many other factors. The list of factors provided herein is exemplary in nature and is not meant to limit the invention. As an example, model 224 may identify a particular posting as a job listing but a user or administrator may manually flag the post as corresponding or not corresponding to a job listing. In response, the model may adjust one or more parameters of the model to make it less or more likely that similar postings will be identified as job listings in the future. Model 224 may also rely on the content of the post 230, by determining whether the post includes items or text generally associated with job listings. Model 224 may also consider comments 228 made by other users regarding the post. Model 224 may also consider other recent posts of the user. For example, if the user has recently posted job listings, it is more likely that the current post may be a job listing. Additionally, the model 224 may consider the posts of other users in the same field who are seeking job candidates, and may infer that the current user is more likely to be seeking candidates if others are also. The model 224 may also incorporate temporal information 234, such as the time of year.

Model 224 may also consider whether the user prefers to create structured or unstructured posts 226, and may take this into account when deciding whether or not to offer the user the opportunity to convert unstructured free-form text 104 into a structured job listing 114.

Posting conversion logic 214 may be configured to present the user with query interface 106 shown in FIG. 1B, to confirm the user's intent to convert the unstructured free-form text 104 to a structured job listing, and with structured job listing interface 114, shown in FIG. 1C, where the user may edit the structure job listing and confirm that the user wishes to post a job listing. Posting conversion logic 214 may be further configured to convert the unstructured text comprising a job description into a structured job posting which may be searchable through the service running on platform server 206.

Platform server 206 may further comprise job seeker logic 216. Job seeker logic 216 handles the detection and identification of potential job-seeking users and the presenting of the identified users with potential matching job listings. Job seeker logic 216 may further comprise platform interaction logic 218, employment ID logic 220 and platform surfacing logic 222.

Platform interaction logic 218 may be configured to access one or more interactions performed by users on the platform server 206. Interactions performed by users may include, for example, a private message between is users on the social networking service, or a posting accessible generally or by specific other users of the social networking service. Platform interaction logic 218 may be further configured to analyze the interactions to identify that the user is currently a job-seeker. Platform interaction logic 218 may utilize model 224, to perform the analysis.

Model 224 may be configured to determine whether a user is a job-seeker based upon several features, for example, whether a user has clicked into a job posting within the certain period of time, based upon the contents of the of their posts and private messages, based on whether the user is recently uploaded a resume to the platform, etc. The list of features provided herein is exemplary in nature and is not meant to limit the invention.

Employment ID logic 220 may be configured to select or identify one or more employment opportunity listings available on platform server 206 in which a user who has been identified as a job-seeker may be interested. Model 224 may make this determination based upon several features including, for example, the user's profile on the social networking service and the user's previous messages and posts on the social networking service.

The model 224 may also rank the order in which potential jobs are presented to the user based upon the probability that a user will be interested in a particular job. The model 224 may consider, for example, the user's education, location, employment experience, interest, connections, etc. in determining the users interest probability or potential interest in a particular job.

Model 224 may also be configured to determine whether user is actively seeking a job or whether the user's interest is passive, based upon several features, and may treat active job-seekers differently than passive job-seekers. For example, active job-seekers may be presented with more job opportunities on a frequent basis, while passive job-seekers may see fewer job opportunities on a less frequent basis.

Platform surfacing logic 222 may be configured to present identified job opportunities to a particular user, in a particular order. The job opportunities may be presented in an interactable listing 126, as shown in FIG. 1E, which may allow the user to scroll through individual job listings 124 utilizing a finger swipe or by manipulating a scrollbar 125.

It should be realized that the configuration of the system shown in FIG. 2 is exemplary in nature, and that many other configurations may be considered for performing the functions of the system, without departing from the scope of the invention.

### Exemplary Methods and Logic

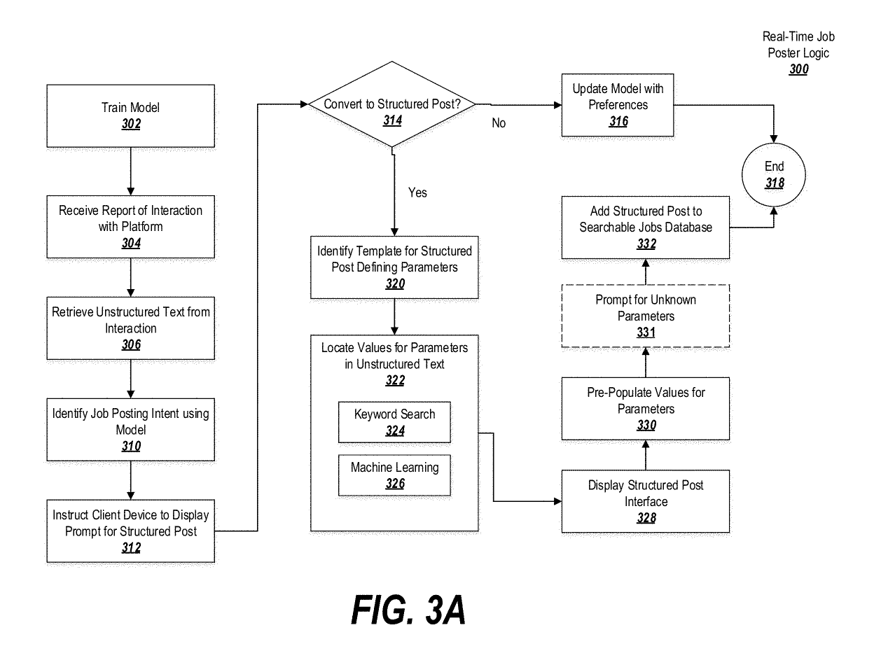

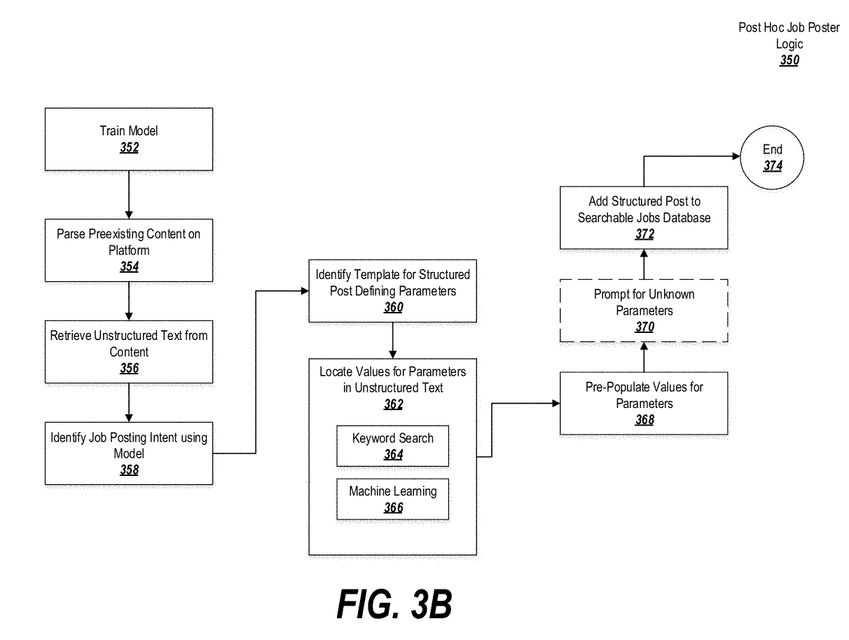

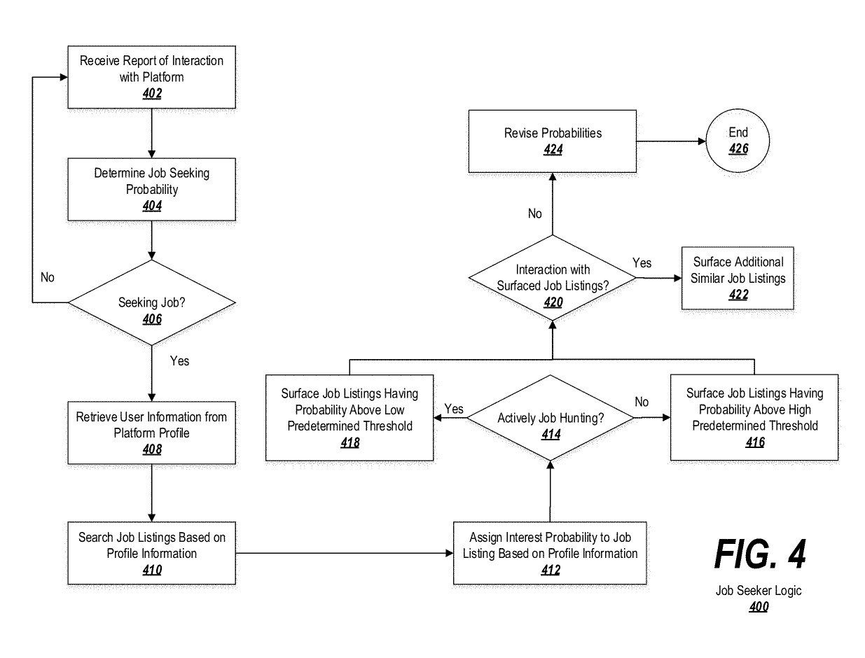

FIGS. 3A-4 depict exemplary logic for carrying out the interactions described above. Although these figures describe exemplary operations as being performed on a server device, it is understood that any of the described steps may be performed on either the client or the server, as appropriate.

FIG. 3A is a flowchart describing exemplary logic for performing an ad hoc analysis of an in-progress post consisting of unstructured free-form text 104 to determine whether the post includes a job listing. At 302, model 224 is trained, based upon previous interactions with users in a manner well-known in the art. It should be noted that the training of model 224 happens over a period of time, and is not a discrete event as may be implied from FIG. 3A. At 304, job posting logic 208 receives a report of an interaction with the platform. The interaction could be, for example, an in-progress posting 102 by a job-posting user in the context of a social networking service. Once job posting logic 208 has been notified of an in-progress posting 102, the unstructured free-form text 104 is retrieved from the interaction at 306 by posting retrieval logic 210. At 310, job posting logic 208 identifies, using model 224, a job posting in the unstructured free-form text 104, using posting analysis logic 212.

At 312, posting conversion logic 214 instructs client device 202-1 to display a prompt querying whether the user wants to create a structured job listing. This prompt may be in the form of query interface 106 as shown in FIG. 1B. At 314, if the job-posting user indicates that he wishes to convert the unstructured free-form text into a structured job listing, a template for structured job listing may be identified by posting conversion logic 214 at 320. At 322, the unstructured free-form text 104 is analyzed to locate values 118 for parameters 116 in the structured job listing. In certain embodiments, this may be achieved by performing a keyword search 324 and/or a trained machine learning model 326 may be used.

At 328, posting conversion logic 214 causes structured post interface 114 to be displayed on sending client device 202-1, as shown in FIG. 1C, and, at 330, pre-populates values 118 for parameters 116 which had previously been identified at 322. The user may also have the opportunity, at this point, at 331, to edit any of the pre-populated values 118 or to fill in values 118 which were not able to be identified at 322. At 332, after the user has indicated that the job posting is complete by clicking button 119, the job posting may be published by adding the listing to a searchable jobs database and/or posting on a job posting service which may or may not be hosted by the social networking service on platform server 206. The process ends at 318.

At 314, if the user chooses not to convert the unstructured free-form text 104 into a structured job listing, the model 224 is updated with the user's preference at 316 and the process ends at 318.

FIG. 3B is a flowchart describing exemplary logic for performing a post hoc analysis of a previously constructed post to determine whether the post includes a job listing. At 352, model 224 is trained. As previously noted with respect to FIG. 3A, the training of model 224 happens over a period of time, and is not a discrete event. At 354, posting retrieval logic 210 parses pre-existing content on the social networking service. The content may be in the form of private messages between users of the service or may be, for example, postings by users of the service. In other embodiments, other pre-existing content may also be searched including, for example, emails, SMS messages, etc. At 356, posting retrieval logic 210 retrieves the unstructured free-form text 104 from its source and, at 358, posting analysis logic 212 identifies a job description within the unstructured free-form text 104 using model 224, as previously described.

The remainder of process 350 of FIG. 3B is identical to the ad hoc job posting logic 300 as shown in FIG. 3A, and a description will not be repeated here for the sake of brevity.

FIG. 4 is a flowchart describing job seeker logic 400, which comprises exemplary logic for determining whether a user is a job seeker and for surfacing job opportunities to the user. At 402, platform interaction logic 218 may receive a report of an interaction by a user with the service on platform server 206. At 404, platform interaction logic 218 determines whether the interaction identified in 402 contains criteria that may identify it as the posting of a job-seeking user, and, at 406, the determination is made that the user making the interaction is seeking a job, either actively or passively. If it is determined that the user making interaction is not seeking a job, job seeker logic 216 returns to 402 to retrieve other interactions from the service running on platform server 206.

If, at 406, it is determined that the user associated with the interaction is seeking a job, user information is retrieved from the user's profile on the service at 408. The user's profile on the service may be utilized by employment ID logic 220 to identify job listings at 410 that may be of interest to the user. At 412, employment ID logic 220 assigns an interest probability to the job listing based upon the user's profile information on the service.

At 414, it is determined if the user is actively job hunting. Model 224 may utilize various features and criteria to make this determination. If it is determined that the user is actively job hunting, at 418, job listings are surfaced and presented to the user which have an interest probability above a low predetermined threshold. Because the interest probability threshold is low, the user will be presented with many more job offerings as an active job-seeking user. If, at 414, it is determined that the user is not actively job hunting, that is, user is a passive job hunter, then job listings are surfaced and presented to the user which have an interest probability above a high predetermined threshold, meaning that the user will be presented with less job listings.

At 420, it is determined if the unit user has interacted with the surfaced job listings and, if so, at 422 additional similar job listings are surfaced and presented to the user. If the user has not interacted with the surfaced job listings, then, at 424, the interest probabilities are revised and the job listings with which the user is presented may decrease in number. The process ends at 426.

The above examples may be implemented by a messaging system that is provided either locally, at a client device, or remotely (e.g., at a remote server). FIGS. 5A-5C depict various examples of messaging systems, and are discussed in more detail below.

### Communication System Overview

FIG. 5A depicts an exemplary centralized communication system 500, in which functionality such as that descried above is integrated into a communication server. The centralized system 500 may implement some or all of the structure and/or operations of a communication service in a single computing entity, such as entirely within a single centralized server device 526.

The communication system 500 may include a computer-implemented system having software applications that include one or more components. Although the communication system 500 shown in FIG. 5A has a limited number of elements in a certain topology, the communication system 500 may include more or fewer elements in alternate topologies.

A communication service 500 may be generally arranged to receive, store, and deliver messages. The communication service 500 may store messages while clients 520, such as may execute on client devices 510, are offline and deliver the messages once the messaging clients are available. Alternatively or in addition, the clients 520 may include social networking functionality.

A client device 510 may transmit messages addressed to a recipient user, user account, or other identifier resolving to a receiving client device 510. In exemplary embodiments, each of the client devices 510 and their respective messaging clients 520 are associated with a particular user or users of the communication service 500. In some embodiments, the client devices 510 may be cellular devices such as smartphones and may be identified to the communication service 500 based on a phone number associated with each of the client devices 510. In some embodiments, each messaging client may be associated with a user account registered with the communication service 500. In general, each messaging client may be addressed through various techniques for the reception of messages. While in some embodiments the client devices 510 may be cellular devices, in other embodiments one or more of the client devices 510 may be personal computers, tablet devices, any other form of computing device.

The client 510 may include on his e or more input devices 512 and one or more output devices 518. The input devices 512 may include, for example, microphones, keyboards, cameras, electronic pens, touch screens, and other devices for receiving inputs including message data, requests, commands, user interface interactions, selections, and other types of input. The output devices 518 may include a speaker, a display device such as a monitor or touch screen, and other devices for presenting an interface to the communication system 500.

The client 510 may include a memory 519, which may be a non-transitory computer readable storage medium, such as one or a combination of a hard drive, solid state drive, flash storage, read only memory, or random access memory. The memory 519 may a representation of an input 514 and/or a representation of an output 516, as well as one or more applications. For example, the memory 519 may store a messaging client 520 and/or a social networking client that allows a user to interact with a social networking service.

The input 514 may be textual, such as in the case where the input device 212 is a keyboard. Alternatively, the input 514 may be an audio recording, such as in the case where the input device 512 is a microphone. Accordingly, the input 514 may be subjected to automatic speech recognition (ASR) logic in order to transform the audio recording to text that is processable by the communication system 500. The ASR logic may be located at the client device 510 (so that the audio recording is processed locally by the client 510 and corresponding text is transmitted to the messaging server 526), or may be located remotely at the messaging server 526 (in which case, the audio recording may be transmitted to the messaging server 526 and the messaging server 526 may process the audio into text). Other combinations are also possible—for example, if the input device 512 is a touch pad or electronic pen, the input 514 may be in the form of handwriting, which may be subjected to handwriting or optical character recognition analysis logic in order to transform the input 512 into processable text.

The client 510 may be provided with a network interface 522 for communicating with a network 524, such as the Internet. The network interface 522 may transmit the input 512 in a format and/or using a protocol compatible with the network 524 and may receive a corresponding output 516 from the network 524.

The network interface 522 may communicate through the network 524 to a messaging server 526. The messaging server 526 may be operative to receive, store, and forward messages between messaging clients.

The messaging server 526 may include a network interface 522, messaging preferences 528, and communications logic 530. The messaging preferences 528 may include one or more privacy settings or other preferences for one or more users and/or message threads. Furthermore, the messaging preferences 528 may include one or more settings, including default settings, for the logic described herein.

The communications logic 530 may include logic for implementing any or all of the above-described features of the present invention. Alternatively or in addition, some or all of the features may be implemented at the client 510-i, such as by being incorporated into an application such as the messaging client 520.

The network interface 522 of the client 510 and/or the messaging server 526 may also be used to communicate through the network 524 with an app server 540. The app server may store software or applications in an app library 544, representing software available for download by the client 510-i and/or the messaging server 526 (among other entities). An app in the app library 544 may fully or partially implement the embodiments described herein. Upon receiving a request to download software incorporating exemplary embodiments, app logic 542 may identify a corresponding app in the app library 544 and may provide (e.g., via a network interface) the app to the entity that requested the software.

The network interface 522 of the client 510 and/or the messaging server 526 may also be used to communicate through the network 524 with a social networking server 536. The social networking server 536 may include or may interact with a social networking graph 538 that defines connections in a social network. Furthermore, the messaging server 526 may connect to the social networking server 536 for various purposes, such as retrieving connection information, messaging history, event details, etc. from the social network.

A user of the client 510 may be an individual (human user), an entity (e.g., an enterprise, business, or third-party application), or a group (e.g., of individuals or entities) that interacts or communicates with or over the social networking server 536. The social-networking server 536 may be a network-addressable computing system hosting an online social network. The social networking server 536 may generate, store, receive, and send social-networking data, such as, for example, user-profile data, concept-profile data, social-graph information, or other suitable data related to the online social network. The social networking server 536 may be accessed by the other components of the network environment either directly or via the network 524.

The social networking server 536 may include an authorization server (or other suitable component(s)) that allows users to opt in to or opt out of having their actions logged by social-networking server 536 or shared with other systems (e.g., third-party systems, such as the messaging server 526), for example, by setting appropriate privacy settings. A privacy setting of a user may determine what information associated with the user may be logged, how information associated with the user may be logged, when information associated with the user may be logged, who may log information associated with the user, whom information associated with the user may be shared with, and for what purposes information associated with the user may be logged or shared. Authorization servers may be used to enforce one or more privacy settings of the users of social-networking server 536 through blocking, data hashing, anonymization, or other suitable techniques as appropriate.

More specifically, one or more of the content objects of the online social network may be associated with a privacy setting. The privacy settings (or “access settings”) for an object may be stored in any suitable manner, such as, for example, in association with the object, in an index on an authorization server, in another suitable manner, or any combination thereof. A privacy setting of an object may specify how the object (or particular information associated with an object) can be accessed (e.g., viewed or shared) using the online social network. Where the privacy settings for an object allow a particular user to access that object, the object may be described as being “visible” with respect to that user. As an example and not by way of limitation, a user of the online social network may specify privacy settings for a user-profile page identify a set of users that may access the work experience information on the user-profile page, thus excluding other users from accessing the information. In particular embodiments, the privacy settings may specify a “blocked list” of users that should not be allowed to access certain information associated with the object. In other words, the blocked list may specify one or more users or entities for which an object is not visible. As an example and not by way of limitation, a user may specify a set of users that may not access photos albums associated with the user, thus excluding those users from accessing the photo albums (while also possibly allowing certain users not within the set of users to access the photo albums).

In particular embodiments, privacy settings may be associated with particular elements of the social networking graph 538. Privacy settings of a social-graph element, such as a node or an edge, may specify how the social-graph element, information associated with the social-graph element, or content objects associated with the social-graph element can be accessed using the online social network. As an example and not by way of limitation, a particular concept node corresponding to a particular photo may have a privacy setting specifying that the photo may only be accessed by users tagged in the photo and their friends. In particular embodiments, privacy settings may allow users to opt in or opt out of having their actions logged by social networking server 536 or shared with other systems. In particular embodiments, the privacy settings associated with an object may specify any suitable granularity of permitted access or denial of access. As an example and not by way of limitation, access or denial of access may be specified for particular users (e.g., only me, my roommates, and my boss), users within a particular degrees-of-separation (e.g., friends, or friends-of-friends), user groups (e.g., the gaming club, my family), user networks (e.g., employees of particular employers, students or alumni of particular university), all users (“public”), no users (“private”), users of third-party systems, particular applications (e.g., third-party applications, external websites), other suitable users or entities, or any combination thereof. Although this disclosure describes using particular privacy settings in a particular manner, this disclosure contemplates using any suitable privacy settings in any suitable manner.

In response to a request from a user (or other entity) for a particular object stored in a data store, the social networking server 536 may send a request to the data store for the object. The request may identify the user associated with the request. The requested data object may only be sent to the user (or a client system 510 of the user) if the authorization server determines that the user is authorized to access the object based on the privacy settings associated with the object. If the requesting user is not authorized to access the object, the authorization server may prevent the requested object from being retrieved from the data store, or may prevent the requested object from be sent to the user. In the search query context, an object may only be generated as a search result if the querying user is authorized to access the object. In other words, the object must have a visibility that is visible to the querying user. If the object has a visibility that is not visible to the user, the object may be excluded from the search results.

In some embodiments, targeting criteria may be used to identify users of the social network for various purposes. Targeting criteria used to identify and target users may include explicit, stated user interests on social-networking server 536 or explicit connections of a user to a node, object, entity, brand, or page on social networking server 536. In addition or as an alternative, such targeting criteria may include implicit or inferred user interests or connections (which may include analyzing a user's history, demographic, social or other activities, friends' social or other activities, subscriptions, or any of the preceding of other users similar to the user (based, e.g., on shared interests, connections, or events)). Particular embodiments may utilize platform targeting, which may involve platform and “like” impression data; contextual signals (e.g., “Who is viewing now or has viewed recently the page for COCA-COLA?”); light-weight connections (e.g., “check-ins”); connection lookalikes; fans; extracted keywords; EMU advertising; inferential advertising; coefficients, affinities, or other social-graph information; friends-of-friends connections; pinning or boosting; deals; polls; household income, social clusters or groups; products detected in images or other media; social- or open-graph edge types; geo-prediction; views of profile or pages; status updates or other user posts (analysis of which may involve natural-language processing or keyword extraction); events information; or collaborative filtering. Identifying and targeting users may also implicate privacy settings (such as user opt-outs), data hashing, or data anonymization, as appropriate.

The centralized embodiment depicted in FIG. 5A may be well-suited to deployment as a new system or as an upgrade to an existing system, because the logic for implementing exemplary embodiments is incorporated into the messaging server 526. In contrast, FIG. 5B depicts an exemplary distributed messaging system 550, in which functionality for implementing exemplary embodiments is distributed and remotely accessible from the messaging server. Examples of a distributed system 550 include a client-server architecture, a 3-tier architecture, an N-tier architecture, a tightly-coupled or clustered architecture, a peer-to-peer architecture, a master-slave architecture, a shared database architecture, and other types of distributed systems.

Many of the components depicted in FIG. 5B are identical to those in FIG. 5A, and a description of these elements is not repeated here for the sake of brevity (the app server 540 is omitted from the Figure for ease of discussion, although it is understood that this embodiment may also employ an app server 540). The primary difference between the centralized embodiment and the distributed embodiment is the addition of a separate bot processing server 552, which hosts the logic 530 for implementing exemplary embodiments. The bot processing server 552 may be distinct from the messaging server 526 but may communicate with the messaging server 526, either directly or through the network 524, to provide the functionality of the logic 530 and the logic 534 to the messaging server 526.

The embodiment depicted in FIG. 5B may be particularly well suited to allow exemplary embodiments to be deployed alongside existing messaging systems, for example when it is difficult or undesirable to replace an existing messaging server. Additionally, in some cases the messaging server 526 may have limited resources (e.g. processing or memory resources) that limit or preclude the addition of the additional pivot functionality. In such situations, the capabilities described herein may still be provided through the separate bot processing server 552.

In still further embodiments, the logic 532 may be provided locally at the client 510-i, for example as part of the messaging client 520. In these embodiments, each client 510-i makes its own determination as to which messages belong to which thread, and how to update the display and issue notifications. As a result, different clients 510-i may display the same conversation differently, depending on local settings (for example, the same messages may be assigned to different threads, or similar threads may have different parents or highlights).

FIG. 5C illustrates an example of a social networking graph 538. In exemplary embodiments, a social networking service may store one or more social graphs 538 in one or more data stores as a social graph data structure via the social networking service.

The social graph 538 may include multiple nodes, such as user nodes 554 and concept nodes 556. The social graph 228 may furthermore include edges 558 connecting the nodes. The nodes and edges of social graph 228 may be stored as data objects, for example, in a data store (such as a social-graph database). Such a data store may include one or more searchable or queryable indexes of nodes or edges of social graph 228.

The social graph 538 may be accessed by a social-networking server 226, client system 210, third-party system (e.g., the translation server 224), or any other approved system or device for suitable applications.

A user node 554 may correspond to a user of the social-networking system. A user may be an individual (human user), an entity (e.g., an enterprise, business, or third-party application), or a group (e.g., of individuals or entities) that interacts or communicates with or over the social-networking system. In exemplary embodiments, when a user registers for an account with the social-networking system, the social-networking system may create a user node 554 corresponding to the user, and store the user node 30 in one or more data stores. Users and user nodes 554 described herein may, where appropriate, refer to registered users and user nodes 554 associated with registered users. In addition or as an alternative, users and user nodes 554 described herein may, where appropriate, refer to users that have not registered with the social-networking system. In particular embodiments, a user node 554 may be associated with information provided by a user or information gathered by various systems, including the social-networking system. As an example and not by way of limitation, a user may provide their name, profile picture, contact information, birth date, sex, marital status, family status, employment, education background, preferences, interests, or other demographic information. In particular embodiments, a user node 554 may be associated with one or more data objects corresponding to information associated with a user. In particular embodiments, a user node 554 may correspond to one or more webpages. A user node 554 may be associated with a unique user identifier for the user in the social-networking system.

In particular embodiments, a concept node 556 may correspond to a concept. As an example and not by way of limitation, a concept may correspond to a place (such as, for example, a movie theater, restaurant, landmark, or city); a website (such as, for example, a website associated with the social-network service or a third-party website associated with a web-application server); an entity (such as, for example, a person, business, group, sports team, or celebrity); a resource (such as, for example, an audio file, video file, digital photo, text file, structured document, or application) which may be located within the social-networking system or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 556 may be associated with information of a concept provided by a user or information gathered by various systems, including the social-networking system. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 556 may be associated with one or more data objects corresponding to information associated with concept node 556. In particular embodiments, a concept node 556 may correspond to one or more webpages.

In particular embodiments, a node in social graph 538 may represent or be represented by a webpage (which may be referred to as a “profile page”). Profile pages may be hosted by or accessible to the social-networking system. Profile pages may also be hosted on third-party websites associated with a third-party server. As an example and not by way of limitation, a profile page corresponding to a particular external webpage may be the particular external webpage and the profile page may correspond to a particular concept node 556. Profile pages may be viewable by all or a selected subset of other users. As an example and not by way of limitation, a user node 554 may have a corresponding user-profile page in which the corresponding user may add content, make declarations, or otherwise express himself or herself. A business page such as business page 205 may comprise a user-profile page for a commerce entity. As another example and not by way of limitation, a concept node 556 may have a corresponding concept-profile page in which one or more users may add content, make declarations, or express themselves, particularly in relation to the concept corresponding to concept node 556.

In particular embodiments, a concept node 556 may represent a third-party webpage or resource hosted by a third-party system. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check in,” “eat,” “recommend,” or another suitable action or activity. A user viewing the third-party webpage may perform an action by selecting one of the icons (e.g., “eat”), causing a client system to send to the social-networking system a message indicating the user's action. In response to the message, the social-networking system may create an edge (e.g., an “eat” edge) between a user node 554 corresponding to the user and a concept node 556 corresponding to the third-party webpage or resource and store edge 558 in one or more data stores.

In particular embodiments, a pair of nodes in social graph 538 may be connected to each other by one or more edges 558. An edge 558 connecting a pair of nodes may represent a relationship between the pair of nodes. In particular embodiments, an edge 558 may include or represent one or more data objects or attributes corresponding to the relationship between a pair of nodes. As an example and not by way of limitation, a first user may indicate that a second user is a “friend” of the first user. In response to this indication, the social-networking system may send a “friend request” to the second user. If the second user confirms the “friend request,” the social-networking system may create an edge 558 connecting the first user's user node 554 to the second user's user node 554 in social graph 538 and store edge 558 as social-graph information in one or more data stores. In the example of FIG. 5C, social graph 538 includes an edge 558 indicating a friend relation between user nodes 554 of user “Amanda” and user “Dorothy.” Although this disclosure describes or illustrates particular edges 558 with particular attributes connecting particular user nodes 554, this disclosure contemplates any suitable edges 558 with any suitable attributes connecting user nodes 554. As an example and not by way of limitation, an edge 558 may represent a friendship, family relationship, business or employment relationship, fan relationship, follower relationship, visitor relationship, subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 538 by one or more edges 558.

In particular embodiments, an edge 558 between a user node 554 and a concept node 556 may represent a particular action or activity performed by a user associated with user node 554 toward a concept associated with a concept node 556. As an example and not by way of limitation, as illustrated in FIG. 5C, a user may “like,” “attended,” “played,” “listened,” “cooked,” “worked at,” or “watched” a concept, each of which may correspond to a edge type or subtype. A concept-profile page corresponding to a concept node 556 may include, for example, a selectable “check in” icon (such as, for example, a clickable “check in” icon) or a selectable “add to favorites” icon. Similarly, after a user clicks these icons, the social-networking system may create a “favorite” edge or a “check in” edge in response to a user's action corresponding to a respective action. As another example and not by way of limitation, a user (user “Carla”) may listen to a particular song (“Across the Sea”) using a particular application (SPOTTY, which is an online music application). In this case, the social-networking system may create a “listened” edge 558 and a “used” edge (as illustrated in FIG. 5C) between user nodes 554 corresponding to the user and concept nodes 556 corresponding to the song and application to indicate that the user listened to the song and used the application. Moreover, the social-networking system may create a “played” edge 558 (as illustrated in FIG. 5C) between concept nodes 556 corresponding to the song and the application to indicate that the particular song was played by the particular application. In this case, “played” edge 558 corresponds to an action performed by an external application (SPOTIFY) on an external audio file (the song “Across the Sea”). Although this disclosure describes particular edges 558 with particular attributes connecting user nodes 554 and concept nodes 556, this disclosure contemplates any suitable edges 558 with any suitable attributes connecting user nodes 554 and concept nodes 556. Moreover, although this disclosure describes edges between a user node 554 and a concept node 556 representing a single relationship, this disclosure contemplates edges between a user node 554 and a concept node 556 representing one or more relationships. As an example and not by way of limitation, an edge 558 may represent both that a user likes and has used at a particular concept. Alternatively, another edge 558 may represent each type of relationship (or multiples of a single relationship) between a user node 554 and a concept node 556 (as illustrated in FIG. 5C between user node 554 for user “Edwin” and concept node 556 for “SPOTIFY”).

In particular embodiments, the social-networking system may create an edge 558 between a user node 554 and a concept node 556 in social graph 538. As an example and not by way of limitation, a user viewing a concept-profile page (such as, for example, by using a web browser or a special-purpose application hosted by the user's client system) may indicate that he or she likes the concept represented by the concept node 556 by clicking or selecting a “Like” icon, which may cause the user's client system to send to the social-networking system a message indicating the user's liking of the concept associated with the concept-profile page. In response to the message, the social-networking system may create an edge 558 between user node 554 associated with the user and concept node 556, as illustrated by “like” edge 558 between the user and concept node 556. In particular embodiments, the social-networking system may store an edge 558 in one or more data stores. In particular embodiments, an edge 558 may be automatically formed by the social-networking system in response to a particular user action. As an example and not by way of limitation, if a first user uploads a picture, watches a movie, or listens to a song, an edge 558 may be formed between user node 554 corresponding to the first user and concept nodes 556 corresponding to those concepts. Although this disclosure describes forming particular edges 558 in particular manners, this disclosure contemplates forming any suitable edges 558 in any suitable manner.

The social graph 538 may further comprise a plurality of product nodes. Product nodes may represent particular products that may be associated with a particular business. A business may provide a product catalog to a consumer-to-business service and the consumer-to-business service may therefore represent each of the products within the product in the social graph 538 with each product being in a distinct product node. A product node may comprise information relating to the product, such as pricing information, descriptive information, manufacturer information, availability information, and other relevant information. For example, each of the items on a menu for a restaurant may be represented within the social graph 538 with a product node describing each of the items. A product node may be linked by an edge to the business providing the product. Where multiple businesses provide a product, each business may have a distinct product node associated with its providing of the product or may each link to the same product node. A product node may be linked by an edge to each user that has purchased, rated, owns, recommended, or viewed the product, with the edge describing the nature of the relationship (e.g., purchased, rated, owns, recommended, viewed, or other relationship). Each of the product nodes may be associated with a graph id and an associated merchant id by virtue of the linked merchant business. Products available from a business may therefore be communicated to a user by retrieving the available product nodes linked to the user node for the business within the social graph 538. The information for a product node may be manipulated by the social-networking system as a product object that encapsulates information regarding the referenced product.

As such, the social graph 538 may be used to infer shared interests, shared experiences, or other shared or common attributes of two or more users of a social-networking system. For instance, two or more users each having an edge to a common business, product, media item, institution, or other entity represented in the social graph 538 may indicate a shared relationship with that entity, which may be used to suggest customization of a use of a social-networking system, including a messaging system, for one or more users.

### Messaging Architecture

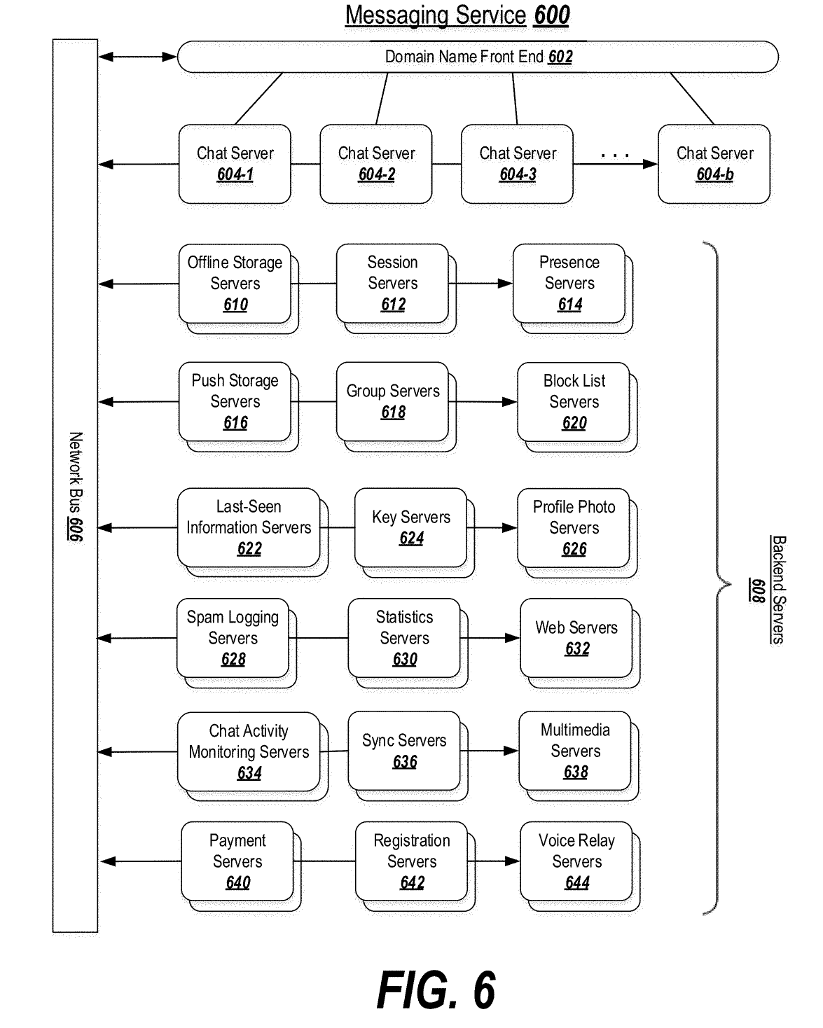

FIG. 6 illustrates an embodiment of a plurality of servers implementing various functions of a messaging service 600. It will be appreciated that different distributions of work and functions may be used in various embodiments of a messaging service 600.

The messaging service 600 may comprise a domain name front end 602. The domain name front end 602 may be assigned one or more domain names associated with the messaging service 600 in a domain name system (DNS). The domain name front end 602 may receive incoming connections and distribute the connections to servers providing various messaging services.

The messaging service 602 may comprise one or more chat servers 604. The chat servers 604 may comprise front-end servers for receiving and transmitting user-to-user messaging updates such as chat messages. Incoming connections may be assigned to the chat servers 604 by the domain name front end 602 based on workload balancing.

The messaging service 600 may comprise backend servers 608. The backend servers 608 may perform specialized tasks in the support of the chat operations of the front-end chat servers 604. A plurality of different types of backend servers 608 may be used. It will be appreciated that the assignment of types of tasks to different backend serves 608 may vary in different embodiments. In some embodiments some of the back-end services provided by dedicated servers may be combined onto a single server or a set of servers each performing multiple tasks divided between different servers in the embodiment described herein. Similarly, in some embodiments tasks of some of dedicated back-end servers described herein may be divided between different servers of different server groups.

The messaging service 600 may comprise one or more offline storage servers 610. The one or more offline storage servers 610 may store messaging content for currently-offline messaging clients in hold for when the messaging clients reconnect.

The messaging service 600 may comprise one or more sessions servers 612. The one or more session servers 612 may maintain session state of connected messaging clients.

The messaging service 600 may comprise one or more presence servers 614. The one or more presence servers 614 may maintain presence information for the messaging service 600. Presence information may correspond to user-specific information indicating whether or not a given user has an online messaging client and is available for chatting, has an online messaging client but is currently away from it, does not have an online messaging client, and any other presence state.

The messaging service 600 may comprise one or more push storage servers 616. The one or more push storage servers 616 may cache push requests and transmit the push requests to messaging clients. Push requests may be used to wake messaging clients, to notify messaging clients that a messaging update is available, and to otherwise perform server-side-driven interactions with messaging clients.

The messaging service 600 may comprise one or more group servers 618. The one or more group servers 618 may maintain lists of groups, add users to groups, remove users from groups, and perform the reception, caching, and forwarding of group chat messages.

The messaging service 600 may comprise one or more block list servers 620. The one or more block list servers 620 may maintain user-specific block lists, the user-specific incoming-block lists indicating for each user the one or more other users that are forbidden from transmitting messages to that user. Alternatively or additionally, the one or more block list servers 620 may maintain user-specific outgoing-block lists indicating for each user the one or more other users that that user is forbidden from transmitting messages to. It will be appreciated that incoming-block lists and outgoing-block lists may be stored in combination in, for example, a database, with the incoming-block lists and outgoing-block lists representing different views of a same repository of block information.

The messaging service 600 may comprise one or more last seen information servers 622. The one or more last seen information servers 622 may receive, store, and maintain information indicating the last seen location, status, messaging client, and other elements of a user's last seen connection to the messaging service 600.

The messaging service 600 may comprise one or more key servers 624. The one or more key servers may host public keys for public/private key encrypted communication.

The messaging service 600 may comprise one or more profile photo servers 626. The one or more profile photo servers 626 may store and make available for retrieval profile photos for the plurality of users of the messaging service 600.

The messaging service 600 may comprise one or more spam logging servers 628. The one or more spam logging servers 628 may log known and suspected spam (e.g., unwanted messages, particularly those of a promotional nature). The one or more spam logging servers 628 may be operative to analyze messages to determine whether they are spam and to perform punitive measures, in some embodiments, against suspected spammers (users that send spam messages).

The messaging service 600 may comprise one or more statistics servers 630. The one or more statistics servers may compile and store statistics information related to the operation of the messaging service 600 and the behavior of the users of the messaging service 600.

The messaging service 600 may comprise one or more web servers 632. The one or more web servers 632 may engage in hypertext transport protocol (HTTP) and hypertext transport protocol secure (HTTPS) connections with web browsers.

The messaging service 600 may comprise one or more chat activity monitoring servers 634. The one or more chat activity monitoring servers 634 may monitor the chats of users to determine unauthorized or discouraged behavior by the users of the messaging service 600. The one or more chat activity monitoring servers 634 may work in cooperation with the spam logging servers 628 and block list servers 620, with the one or more chat activity monitoring servers 634 identifying spam or other discouraged behavior and providing spam information to the spam logging servers 628 and blocking information, where appropriate to the block list servers 620.

The messaging service 600 may comprise one or more sync servers 636. The one or more sync servers 636 may sync the communication system 500 with contact information from a messaging client, such as an address book on a mobile phone, to determine contacts for a user in the messaging service 600.

The messaging service 600 may comprise one or more multimedia servers 638. The one or more multimedia servers may store multimedia (e.g., images, video, audio) in transit between messaging clients, multimedia cached for offline endpoints, and may perform transcoding of multimedia.

The messaging service 600 may comprise one or more payment servers 640. The one or more payment servers 640 may process payments from users. The one or more payment servers 640 may connect to external third-party servers for the performance of payments.

The messaging service 600 may comprise one or more registration servers 642. The one or more registration servers 642 may register new users of the messaging service 600.

The messaging service 600 may comprise one or more voice relay servers 644. The one or more voice relay servers 644 may relay voice-over-internet-protocol (VoIP) voice communication between messaging clients for the performance of VoIP calls.

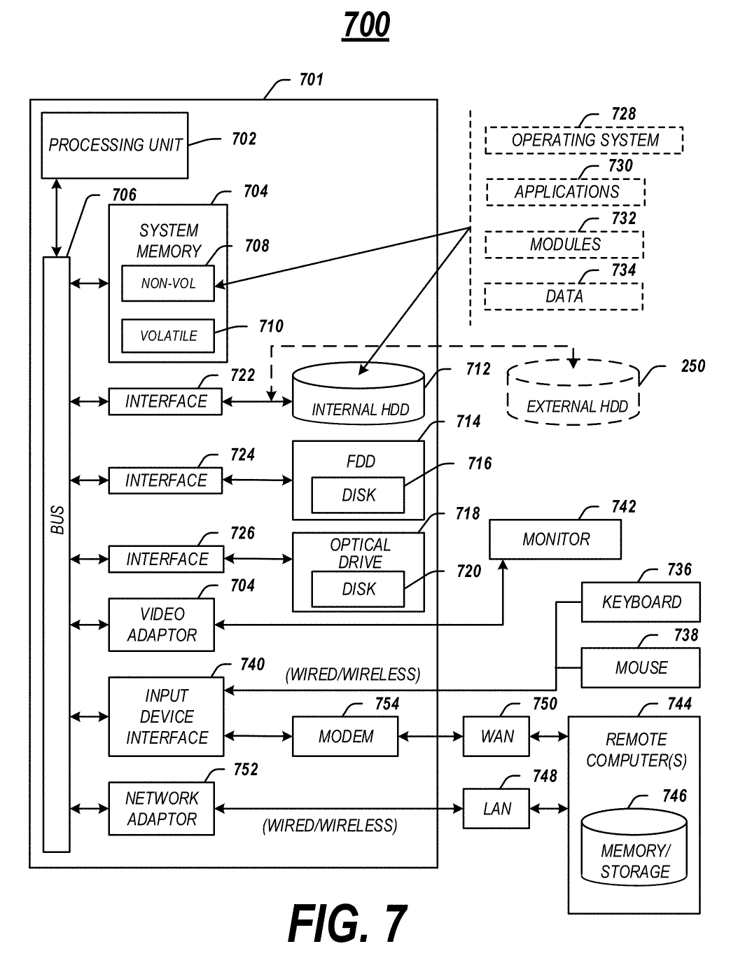

The above-described methods may be embodied as instructions on a computer readable medium or as part of a computing architecture. FIG. 7 illustrates an embodiment of an exemplary computing architecture 700 suitable for implementing various embodiments as previously described. In one embodiment, the computing architecture 700 may comprise or be implemented as part of an electronic device, such as a computer 701. The embodiments are not limited in this context.

As used in this application, the terms “system” and “component” are intended to refer to a computer-related entity, either hardware, a combination of hardware and software, software, or software in execution, examples of which are provided by the exemplary computing architecture 700. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 700 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 700.

As shown in FIG. 7, the computing architecture 700 comprises a processing unit 702, a system memory 704 and a system bus 706. The processing unit 702 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 702.

The system bus 706 provides an interface for system components including, but not limited to, the system memory 704 to the processing unit 702. The system bus 706 can be any of several types of bus structure that may further interconnect to a memory bus (with or without a memory controller), a peripheral bus, and a local bus using any of a variety of commercially available bus architectures. Interface adapters may connect to the system bus 706 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 700 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 704 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 7, the system memory 704 can include non-volatile memory 708 and/or volatile memory 710. A basic input/output system (BIOS) can be stored in the non-volatile memory 708.

The computing architecture 700 may include various types of computer-readable storage media in the form of one or more lower speed memory units, including an internal (or external) hard disk drive (HDD) 712, a magnetic floppy disk drive (FDD) 714 to read from or write to a removable magnetic disk 716, and an optical disk drive 718 to read from or write to a removable optical disk 720 (e.g., a CD-ROM or DVD). The HDD 712, FDD 714 and optical disk drive 720 can be connected to the system bus 706 by an HDD interface 722, an FDD interface 724 and an optical drive interface 726, respectively. The HDD interface 722 for external drive implementations can include at least one or both of Universal Serial Bus (USB) and IEEE 694 interface technologies.

The drives and associated computer-readable media provide volatile and/or nonvolatile storage of data, data structures, computer-executable instructions, and so forth. For example, a number of program modules can be stored in the drives and memory units 708, 712, including an operating system 728, one or more application programs 730, other program modules 732, and program data 734. In one embodiment, the one or more application programs 730, other program modules 732, and program data 734 can include, for example, the various applications and/or components of the communication system 500.

A user can enter commands and information into the computer 701 through one or more wire/wireless input devices, for example, a keyboard 736 and a pointing device, such as a mouse 738. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 702 through an input device interface 740 that is coupled to the system bus 706, but can be connected by other interfaces such as a parallel port, IEEE 694 serial port, a game port, a USB port, an IR interface, and so forth.

A monitor 742 or other type of display device is also connected to the system bus 706 via an interface, such as a video adaptor 744. The monitor 742 may be internal or external to the computer 701. In addition to the monitor 742, a computer typically includes other peripheral output devices, such as speakers, printers, and so forth.

The computer 701 may operate in a networked environment using logical connections via wire and/or wireless communications to one or more remote computers, such as a remote computer 744. The remote computer 744 can be a workstation, a server computer, a router, a personal computer, portable computer, microprocessor-based entertainment appliance, a peer device or other common network node, and typically includes many or all of the elements described relative to the computer 701, although, for purposes of brevity, only a memory/storage device 746 is illustrated. The logical connections depicted include wire/wireless connectivity to a local area network (LAN) 748 and/or larger networks, for example, a wide area network (WAN) 750. Such LAN and WAN networking environments are commonplace in offices and companies, and facilitate enterprise-wide computer networks, such as intranets, all of which may connect to a global communications network, for example, the Internet.

When used in a LAN networking environment, the computer 701 is connected to the LAN 748 through a wire and/or wireless communication network interface or adaptor 752. The adaptor 752 can facilitate wire and/or wireless communications to the LAN 748, which may also include a wireless access point disposed thereon for communicating with the wireless functionality of the adaptor 752.

When used in a WAN networking environment, the computer 701 can include a modem 754, or is connected to a communications server on the WAN 750, or has other means for establishing communications over the WAN 750, such as by way of the Internet. The modem 754, which can be internal or external and a wire and/or wireless device, connects to the system bus 706 via the input device interface 740. In a networked environment, program modules depicted relative to the computer 701, or portions thereof, can be stored in the remote memory/storage device 746. It will be appreciated that the network connections shown are exemplary and other means of establishing a communications link between the computers can be used.

The computer 701 is operable to communicate with wire and wireless devices or entities using the IEEE 802 family of standards, such as wireless devices operatively disposed in wireless communication (e.g., IEEE 802.13 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.13x (a, b, g, n, etc.) to provide secure, reliable, fast wireless connectivity. A Wi-Fi network can be used to connect computers to each other, to the Internet, and to wire networks (which use IEEE 802.3-related media and functions).

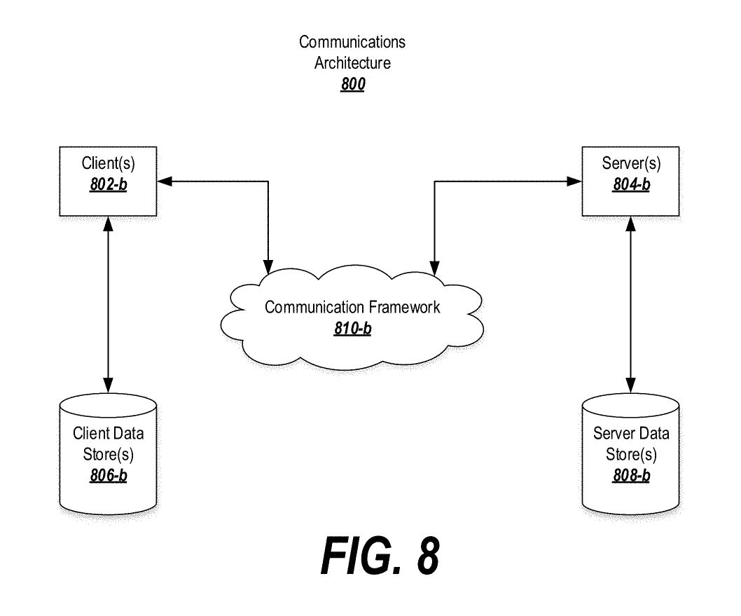

FIG. 8 is a block diagram depicting an exemplary communications architecture 800 suitable for implementing various embodiments as previously described. The communications architecture 800 includes various common communications elements, such as a transmitter, receiver, transceiver, radio, network interface, baseband processor, antenna, amplifiers, filters, power supplies, and so forth. The embodiments, however, are not limited to implementation by the communications architecture 800.

As shown in FIG. 8, the communications architecture 800 includes one or more clients 802 and servers 804. The clients 802 may implement the client device 510. The servers 804 may implement the server device 526. The clients 802 and the servers 804 are operatively connected to one or more respective client data stores 806 and server data stores 808 that can be employed to store information local to the respective clients 802 and servers 804, such as cookies and/or associated contextual information.

The clients 802 and the servers 804 may communicate information between each other using a communication framework 810. The communications framework 810 may implement any well-known communications techniques and protocols. The communications framework 810 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 810 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.8a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 802 and the servers 804. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

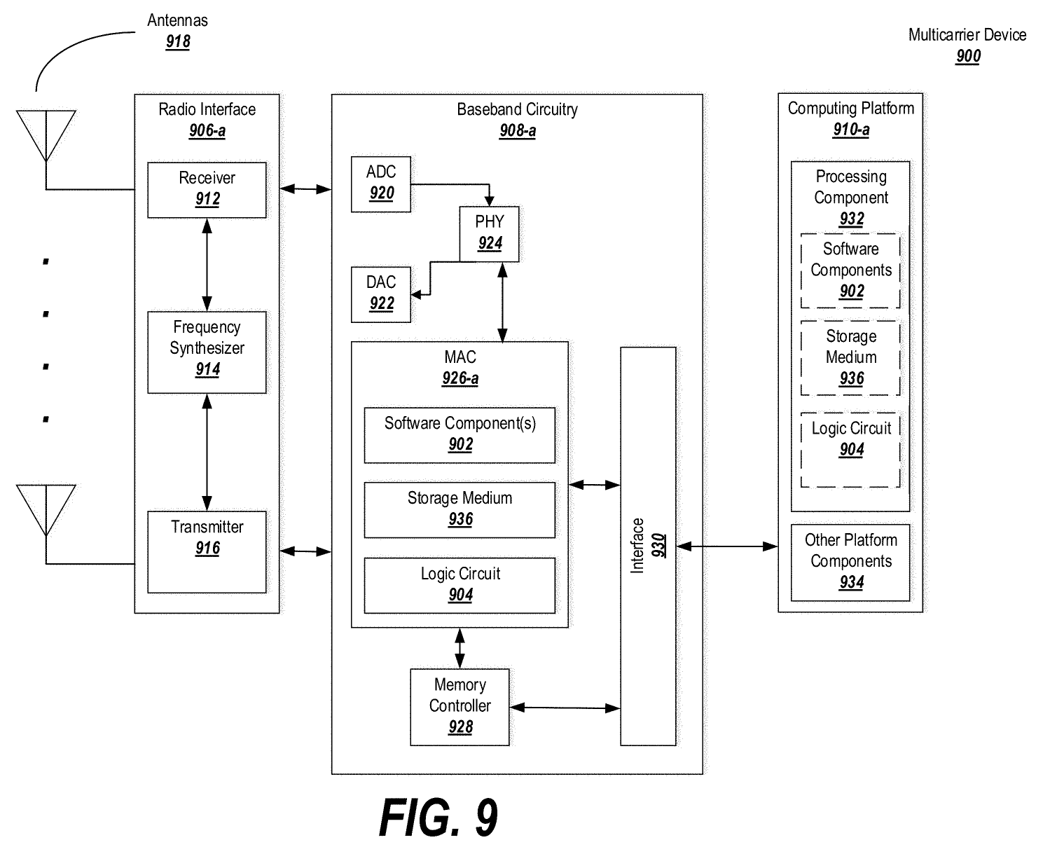

FIG. 9 illustrates an embodiment of a device 900 for use in a multicarrier OFDM system, such as the communication system 500. The device 900 may implement, for example, software components 902 as described with reference to the messaging component logic 600, the intent determination logic 700, and the group selection logic 800. The device 900 may also implement a logic circuit 904. The logic circuit 904 may include physical circuits to perform operations described for the messaging system 600. As shown in FIG. 9, device 900 may include a radio interface 906, baseband circuitry 908, and a computing platform 910, although embodiments are not limited to this configuration.

The device 900 may implement some or all of the structure and/or operations for the communication system 500 and/or logic circuit 904 in a single computing entity, such as entirely within a single device. Alternatively, the device 900 may distribute portions of the structure and/or operations for the messaging system 600 and/or logic circuit 904 across multiple computing entities using a distributed system architecture, such as a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

In one embodiment, the radio interface 906 may include a component or combination of components adapted for transmitting and/or receiving single carrier or multi-carrier modulated signals (e.g., including complementary code keying (CCK) and/or orthogonal frequency division multiplexing (OFDM) symbols) although the embodiments are not limited to any specific over-the-air interface or modulation scheme. The radio interface 906 may include, for example, a receiver 912, a transmitter 914 and/or a frequency synthesizer 916. The radio interface 906 may include bias controls, a crystal oscillator and/or one or more antennas 918. In another embodiment, the radio interface 906 may use external voltage-controlled oscillators (VCOs), surface acoustic wave filters, intermediate frequency (IF) filters and/or RF filters, as desired. Due to the variety of potential RF interface designs an expansive description thereof is omitted.

The baseband circuitry 908 may communicate with the radio interface 906 to process receive and/or transmit signals and may include, for example, an analog-to-digital converter 920 for down converting received signals, and a digital-to-analog converter 922 for up-converting signals for transmission. Further, the baseband circuitry 908 may include a baseband or physical layer (PHY) processing circuit 924 for PHY link layer processing of respective receive/transmit signals. The baseband circuitry 908 may include, for example, a processing circuit 926 for medium access control (MAC)/data link layer processing. The baseband circuitry 908 may include a memory controller 928 for communicating with the processing circuit 926 and/or a computing platform 910, for example, via one or more interfaces 930.

In some embodiments, the PHY processing circuit 924 may include a frame construction and/or detection module, in combination with additional circuitry such as a buffer memory, to construct and/or deconstruct communication frames, such as radio frames. Alternatively or in addition, the MAC processing circuit 926 may share processing for certain of these functions or perform these processes independent of the PHY processing circuit 924. In some embodiments, MAC and PHY processing may be integrated into a single circuit.

The computing platform 910 may provide computing functionality for the device 900. As shown, the computing platform 910 may include a processing component 932. In addition to, or alternatively of, the baseband circuitry 908, the device 900 may execute processing operations or logic for the communication system 500 and logic circuit 904 using the processing component 932. The processing component 932 (and/or the PHY 924 and/or MAC 926) may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The computing platform 910 may further include other platform components 934. Other platform components 934 include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information.

The device 900 may be, for example, an ultra-mobile device, a mobile device, a fixed device, a machine-to-machine (M2M) device, a personal digital assistant (PDA), a mobile computing device, a smart phone, a telephone, a digital telephone, a cellular telephone, user equipment, eBook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, television, digital television, set top box, wireless access point, base station, node B, evolved node B (eNB), subscriber station, mobile subscriber center, radio network controller, router, hub, gateway, bridge, switch, machine, or combination thereof. Accordingly, functions and/or specific configurations of the device 900 described herein, may be included or omitted in various embodiments of the device 900, as suitably desired. In some embodiments, the device 900 may be configured to be compatible with protocols and frequencies associated one or more of the 3GPP LTE Specifications and/or IEEE 1402.16 Standards for WMANs, and/or other broadband wireless networks, cited herein, although the embodiments are not limited in this respect.

Embodiments of device 900 may be implemented using single input single output (SISO) architectures. However, certain implementations may include multiple antennas (e.g., antennas 918) for transmission and/or reception using adaptive antenna techniques for beamforming or spatial division multiple access (SDMA) and/or using MIMO communication techniques.

The components and features of the device 900 may be implemented using any combination of discrete circuitry, application specific integrated circuits (ASICs), logic gates and/or single chip architectures. Further, the features of the device 900 may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It will be appreciated that the exemplary device 900 shown in the block diagram of FIG. 9 may represent one functionally descriptive example of many potential implementations. Accordingly, division, omission or inclusion of block functions depicted in the accompanying figures does not infer that the hardware components, circuits, software and/or elements for implementing these functions would be necessarily be divided, omitted, or included in embodiments.

At least one computer-readable storage medium 936 may include instructions that, when executed, cause a system to perform any of the computer-implemented methods described herein.

### General Notes on Terminology

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1. A computer-readable medium storing instructions that, when executed by a processor, cause the processor to:
access unstructured text on a platform;
identify that the unstructured text corresponds to an employment opportunity; and
convert the unstructured text into a structured job posting, the structured job posting being searchable by the platform.

2. The medium of claim 1, wherein the instructions for identifying that the unstructured text corresponds to an employment opportunity comprise instructions for analyzing the unstructured text using a detector model trained using information from the platform.

3. The medium of claim 2, wherein the information from the platform comprises one or more of: user feedback from the platform, platform administrator actions, corrections to previous job postings, content of previous job postings, existing posts of an originator of the unstructured text, a time of year, whether other employers in similar fields as the originator are currently posting job openings; and whether the originator prefers to do structured or unstructured posts.

4. The medium of claim 1, wherein accessing the unstructured text comprises analyzing the unstructured text in real time as the unstructured text is entered.

5. The medium of claim 4, further storing instructions for, upon identifying that the unstructured text corresponds to an employment opportunity, instructing a display of an originator of the unstructured text to display a job posting interface for entering structured data.

6. The medium of claim 1, wherein accessing the unstructured text comprises analyzing previously entered unstructured text on the platform.

7. The medium of claim 1, further comprising normalizing language of the structured job posting.

8. A system comprising:
a processor circuit;
posting retrieval logic executable on the processor circuit, the posting retrieval logic configured to access unstructured text on a platform;
posting analysis logic executable on the processor circuit, the posting analysis logic configured to identify that the unstructured text corresponds to an employment opportunity; and
posting conversion logic executable on the processor circuit, the posting conversion logic configured to convert the unstructured text into a structured job posting, the structured job posting being searchable by the platform.

9. The system of claim 8, wherein the instructions for identifying that the unstructured text corresponds to an employment opportunity comprise instructions for analyzing the unstructured text using a detector model trained using information from the platform.

10. The system of claim 9, wherein the information from the platform comprises one or more of: user feedback from the platform, platform administrator actions, corrections to previous job postings, content of previous job postings, existing posts of an originator of the unstructured text, a time of year, whether other employers in similar fields as the originator are currently posting job openings; and whether the originator prefers to do structured or unstructured posts.

11. The system of claim 8, wherein accessing the unstructured text comprises analyzing the unstructured text in real time as the unstructured text is entered.

12. The system of claim 11, further storing instructions for, upon identifying that the unstructured text corresponds to an employment opportunity, instructing a display of an originator of the unstructured text to display a job posting interface for entering structured data.

13. The system of claim 8, wherein accessing the unstructured text comprises analyzing previously entered unstructured text on the platform.

14. The system of claim 8, further comprising normalizing language of the structured job posting.

15. A method, comprising:
accessing unstructured text on a platform;
identifying that the unstructured text corresponds to an employment opportunity; and
converting the unstructured text into a structured job posting, the structured job posting being searchable by the platform.

16. The method of claim 15, wherein the instructions for identifying that the unstructured text corresponds to an employment opportunity comprise instructions for analyzing the unstructured text using a detector model trained using information from the platform.

17. The method of claim 16, wherein the information from the platform comprises one or more of: user feedback from the platform, platform administrator actions, corrections to previous job postings, content of previous job postings, existing posts of an originator of the unstructured text, a time of year, whether other employers in similar fields as the originator are currently posting job openings; and whether the originator prefers to do structured or unstructured posts.

18. The method of claim 15, wherein accessing the unstructured text comprises analyzing the unstructured text in real time as the unstructured text is entered.

19. The method of claim 18, further comprising, upon identifying that the unstructured text corresponds to an employment opportunity, instructing a display of an originator of the unstructured text to display a job posting interface for entering structured data.

20. The method of claim 15, further comprising normalizing language of the structured job posting.
